(19) United States
(12) Patent Application Publication
(10) Pub. No.: US 2006/0003709 A1
(43) Pub. Date: Jan. 5, 2006

(54) Protective enclosure for a mobile terminal

(75) Inventor: Joseph Stuart Wood, Andover, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/881,898

(22) Filed: Jun. 30, 2004

(51) Int. Cl. H04Q 7/20

(52) U.S. Cl. 455/90.3

(57) ABSTRACT

A case is provided to protect a mobile terminal. The case includes a housing, typically formed of a waterproof material to prevent the incursion of water or other contaminants. The housing may include two portions with a gasket therebetween to create a hermetic seal. As such, the case and the mobile terminal may be buoyant. The housing may carry input component(s) for receiving user input and/or output component(s) for providing user output. The housing also carries a signal processor which converts any user input to signals that the mobile terminal is capable of processing. Similarly, the signal processor may convert any signals received by the mobile terminal to signals that the output component is capable of processing. The input, output, and signal processing components may be removable from the housing while still being capable of communicating with the mobile terminal so as to be used as a headset.

### FIELD OF THE INVENTION

The present invention relates to protective enclosures for mobile terminals, specifically, the invention relates to protective cases that allow for use of the device while the device is protected within the sealed enclosure.

### BACKGROUND OF THE INVENTION

Wireless communication has advanced significantly over the past few decades. Today, mobile terminals (such as mobile phones, pagers, personal digital assistants, and similar devices) play an important role in society. An increasingly large percentage of the population carries some sort of mobile terminal. People of all ages and walks of life use these mobile terminals to communicate, access the internet, play games, store information, and organize their calendars. People often rely on having easy access to their mobile terminals at all times.

One of the most important characteristics of a mobile terminal is its portability. Consumers constantly demand smaller and lighter mobile terminals that are easier to carry around on a day-to-day basis. In response to consumer demand, today's mobile terminals are often designed to be easily carried in a pocket or handbag or attached to a belt. To achieve smaller sizes and weights, today's mobile devices often lack any kind of significant protection from the elements. Most of the mobile terminals today are highly susceptible to water, dust, and dirt, and few have any significant shock protection.

As consumers increasingly rely on their mobile terminals, they desire to take their mobile terminals everywhere they go and have access to them at any time of day. As a result, today's mobile devices are frequently used in environments hostile to the mobile terminal's electronics. For example, a person who takes a cell phone, PDA, or similar device, to the beach risks harming the device by getting the device sandy or wet. Likewise, someone who works outdoors and is exposed to the elements may desire to have a mobile terminal that is water, dirt, and shock resistant. Even, sitting by the pool or on a boat talking on a mobile phone could be disastrous if the phone is splashed or accidentally dropped in the water. Countless other situations exist, like jogging, hiking, camping, or attending sporting events, where a person may desire to have their mobile device handy but at the same time may not wish to risk exposing the device to potentially harmful environments.

Since a mobile terminal is often a significant investment for the user and would, at the least, be inconvenient to replace, a means of adequately protecting the terminal is needed. Typical protective cases that are currently available consist of flexible leather or plastic jackets that fit snuggly over the terminal. In order for the mobile terminal to be useable with these protective covers in place, these covers generally have cutouts that expose the input and output components of the terminal, such as the keypads, speakers, and microphones. As a result, such covers provide little protection from water, sand, and dirt, and provide almost no added shock protection if the terminal is dropped.

Hard plastic cases that exist in the art, such as that described by U.S. Pat. No. 6,456,487, are generally not waterproof and may require covers to be sealed against the elements. Also, some cases require that the terminal be removed from the case prior to use. Similarly, a person could wrap their terminal in a waterproof plastic bag, but again this would require removal of the terminal prior to use. As a result, cases that require the terminal to be removed for use provide no protection to the terminal during use, when the terminal is often most vulnerable.

Wireless headsets can be used to access a mobile phone while the phone is stored in a secure location. These headsets generally communicate with the mobile terminal using Bluetooth® wireless technology. Bluetooth® wireless technology enables cable-free connections by using radio frequency signals to communicate with the mobile terminal. For the headsets to work, the mobile terminal must be in close proximity to the headset. As a result, the mobile terminal must typically be with the user anyway and, therefore, will still need some means of protection. The small size of the headset limits the input, output, and power components that can be placed on the headset. Furthermore, a person using a headset with a mobile phone while the phone is protected in a handbag or backpack cannot see the display on the phone. To see the phone, the person would have to take it out of the bag, thus exposing it to the harsh environment from which the person was protecting it. Finally, these headsets are not waterproof themselves.

Accordingly, a device is needed that allows consumers the ability to use their small, lightweight, mobile terminals in all kinds of environments without worrying about harming or destroying the terminal. Ideally, the protective device should be waterproof, buoyant, and able to absorb the shock associated with dropping the mobile terminal. At the same time, it would be beneficial to be able to easily use a mobile device and enjoy much of its rich functionality while it is protected.

### BRIEF SUMMARY OF THE INVENTION

In light of the forgoing background, embodiments of the present invention provide a case, a mobile terminal assembly, and associated method, for protecting a mobile terminal whether or not the terminal is in use. The mobile terminal may be a mobile phone, a personal digital assistant (PDA), a pager, a MP3 player, or any similar device.

The present invention is directed to a case designed to protect a mobile terminal therein. The case comprises a housing adapted to define an opened position for receiving a mobile terminal and a closed position for securing the mobile terminal therein. Advantageously, the housing is formed of a waterproof material and is sealed in the closed position so as to protect the mobile terminal from the incursion of water or other environmental contaminants. The housing may carry input component(s), such as a microphone and/or keypad, for receiving user input. The housing also carries a signal processor which converts the user input received by the input components to signals that the mobile terminal is capable of processing. Similarly, the housing may carry output component(s), such as a speaker, for providing user output. The signal processor converts signals received from the mobile terminal to signals that the output component is capable of processing.

In one embodiment, the housing is comprised of at least two portions that may be joined by a hinge coupling and may be secured in the closed position by a latch. The housing may include a gasket between portions of the housing to create a hermetic seal. In one embodiment, the case is buoyant with the mobile terminal secured therein. In addition, the housing may be at least partially transparent so that the mobile terminal, and any display of the mobile terminal, may be seen from the outside of the case while the mobile terminal is secured therein.

As noted, the case contains input component(s), such as microphones and keypads, and output component(s), such as a speakers, LCDs, and LEDs. These input and output components may correspond to the input and output components on the mobile terminal allowing the user to use some or all of the functions of the mobile terminal while it is secured within the case. To accomplish this, the case includes a signal processor to convert and transmit signals from the case to the mobile terminal therein and vice versa. In one embodiment, the case may communicate with the mobile terminal therein using radio frequency signals. In another alternative embodiment the mobile terminal may be hardwired to the case so that the case and the mobile terminal can communicate using electronic signals. The case may also have its own power supply.

In one advantageous embodiment, the input, output, and signal processing components carried by the housing are removable from the housing while still being capable of communicating with the mobile terminal. The removable components could then be used as a headset, such as a wireless headset, or similar device. Thus, the headset could be placed in the case along with a mobile terminal to permit the mobile terminal to be utilized while protecting the mobile terminal and the headset from water and other environmental contaminants, and can thereafter be removed and utilized in a conventional fashion.

The case of embodiments of the present invention therefore advantageously protects the mobile terminal secured therein from exposure to water and other environmental contaminants. The case is designed, however, to permit the mobile terminal to continue to be used in a conventional manner while secured in the case by providing input and output components that are carried by the housing to receive user input and provide user output. Moreover, one embodiment of the present invention provides a particularly economical case by permitting the microphone, speaker and signal processor of a headset, such as a wireless headset, to be inserted into the housing so as to serve corresponding functions therein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a three-view diagram of an embodiment of the exterior of a case of the present invention;

FIG. 2 is a diagram of an embodiment of the opened case of the present invention;

FIG. 3 is a diagram of an embodiment of the present invention of an opened case with a mobile terminal secured therein;

FIG. 4 is a diagram of an embodiment of the present invention of the back view of an opened case showing the electronic, input, and output components of the case; and

FIG. 5 is a diagram of an embodiment of the present invention of the front view of the case without the mobile terminal showing electronic, input, and output components of the case.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

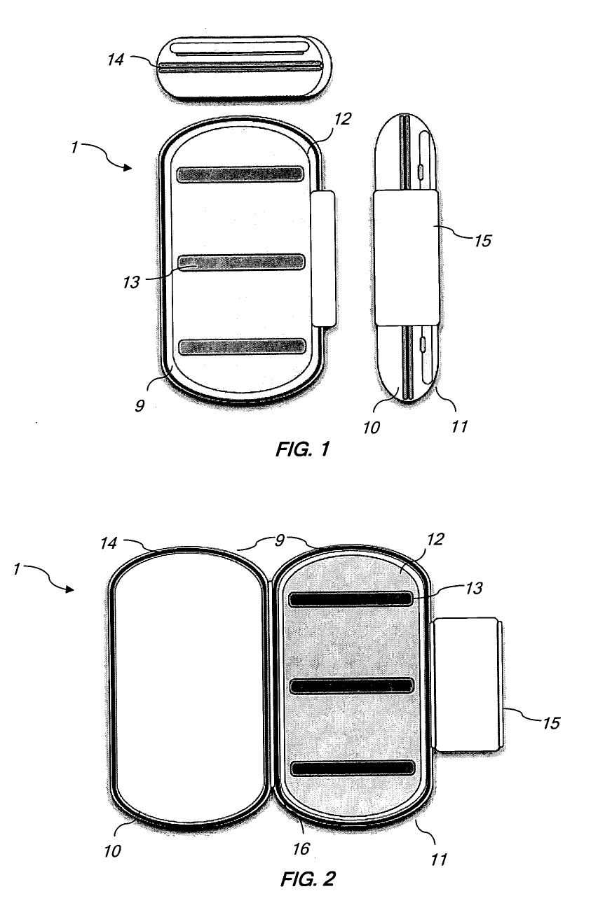

Referring now to FIGS. 1 and 2, an exemplary embodiment of a mobile terminal protective case 1 is shown. FIG. 1 shows three views of the case: the front plan view, top, and side views. FIG. 2 shows a view of the basic case in the opened position ready to receive the mobile terminal. As shown, the case includes a housing 9 designed to house a mobile terminal therein. The housing 9 may be made of any suitable material. In one embodiment, the housing is comprised of a substantially rigid material to physically protect the mobile terminal from an impact, such as if the case is dropped. In addition, the housing may be formed of a waterproof material to protect the mobile terminal from water and other liquids. Moreover, the housing may be formed of a material that is buoyant so as to aid in the floatation of the case, even with the mobile terminal secured therein. As such, the mobile terminal may be protected from damage otherwise attributable to moisture or other contaminants while in the case. In one embodiment, for example, the housing is formed of a polycarbonate material.

The material that forms the housing, such as polycarbonate, may be selected to be at least partially transparent to enable the user to view the mobile terminal and any display of the mobile terminal while it is secured within the housing. It should be understood, however, that the housing does not have to be made of a polycarbonate material, nor does the case have to be clear. The case could be partially transparent so that only portions of the mobile terminal or the interior case components are visible from the outside. For example, the housing could provide a window through which the mobile terminal's display can be seen. Such a design may be desirable if the case is to carry a decorative design or if the case is designed to be a reflective color to protect the mobile terminal from the sun. Alternatively, for some uses or mobile terminals, the housing may not be transparent at all and is opaque instead.

The housing may be comprised of at least two portions. In the embodiment shown in FIGS. 1 and 2, for example, the housing 9 is comprised of two portions 10 and 11. In this embodiment, the two portions 10 and 11 are connected by a hinge coupling 16 that allows the housing to be opened to receive the mobile terminal and closed to secure the terminal therein. The hinge coupling 16 could be a separate hinge coupling the portions of the housing together, or, alternatively, the hinge coupling 16 could be integral with the portions themselves. A latch 15 may secure the housing in a closed position. It should be understood, however, that the housing 9 could be comprised of a single portion or any number of multiple portions. Likewise, the portions need not be joined and secured using a hinge and latch system. For example, the portions could slide together, latch together, or could simply be held together using a strap or rubber band.

The embodiment of the case shown further comprises a backing 12 and a fastener, such as one or more straps 13, for securing the mobile terminal within the housing 9. In the preferred embodiment, the backing comprises soft foam and is applied to the interior of the back portion 11 of the housing. While three straps 13 are shown in the figures, any number of straps could be used to secure the mobile terminal within the case. In alternative embodiments, straps may not be used at all. For example, the mobile terminal could be secured within the case using Velcro, tape, latches, screws, buttons, elastic bands, or any similar fastening device. In yet another embodiment, the foam backing 12 could be designed so that the mobile terminal fits snuggly within a cutout in the foam. In such a case fasteners 13 may not be necessary.

The embodiment of the case shown in FIGS. 1 and 2 further comprises a gasket 14, typically formed of rubber, that lines the rims of one or both of the portions 10 and 11 of the housing. When the housing is in a closed position, the gaskets 14 provide a seal capable of preventing liquid, dust, dirt, and sand from getting inside the case, thereby protecting the mobile terminal. In one embodiment, the case is designed to be buoyant and to float with the mobile terminal secured within. This buoyancy is primarily achieved by selecting a relatively lightweight material, such as polycarbonate, to form the housing and sealing the housing in an airtight manner by means of the gasket. Thus, even if dropped in water, the case carrying the mobile terminal can be recovered without damaging the mobile terminal.

Although not shown in the figures, alternative embodiments of the case would have components designed to aid in the carrying of the case. In one embodiment, the case would have a loop formed into the housing to allow a line, cord, carabineer, or similar item to be attached to the case for securing it to other items, such as a wrist, belt, bag, or chair. Alternative embodiments may have belt loops, clips, or other fasteners attached to or formed in the housing.

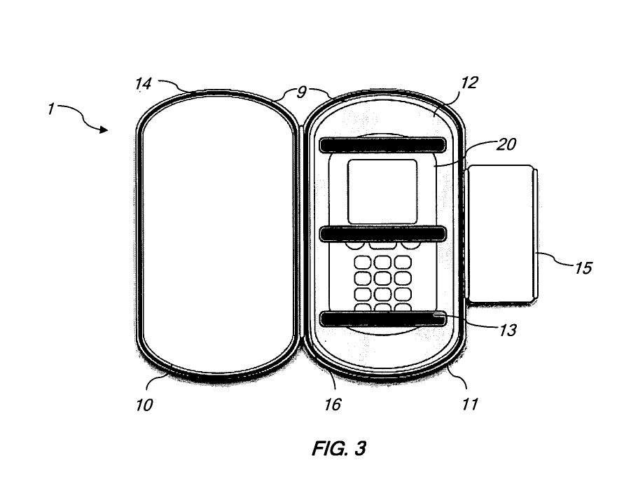

FIG. 3 shows an embodiment of a mobile terminal assembly, with case 1 in an opened position with the mobile terminal 20 secured to the backing 12 using straps 13. Although the figure depicts a mobile phone secured in the case, the mobile terminal could alternatively be a pager, PDA, portable MP3 player, or similar portable electronic device. It should also be noted that the case 1 could be designed and manufactured in a single one-size-fits-all form, in several sizes (e.g., small, medium, large), or custom fit for the particular model of mobile terminal.

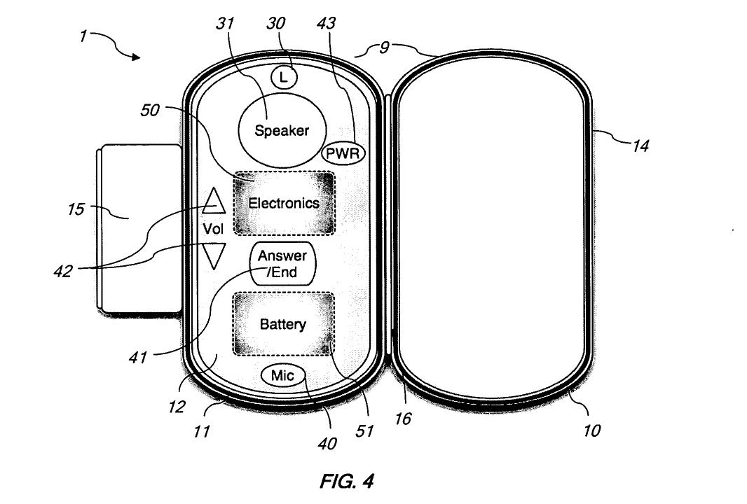

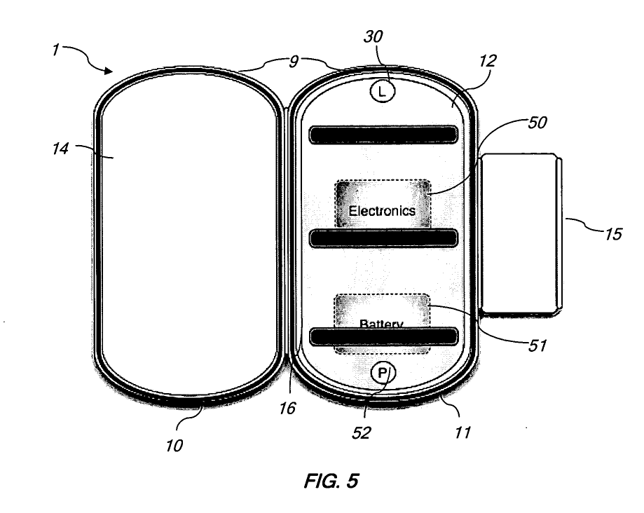

Referring now to FIGS. 4 and 5, an exemplary embodiment of the input, output, and electronic components of the protective case is shown. It is noted that, as used herein, input/output components refers to any one or more of the input components and/or any one or more of the output components. FIG. 4 shows the back view of case 1 in an opened position. FIG. 5 shows the front view of case 1 in the opened position. Typically, most of the input, output, and electronic components of the case are carried by the back portion 11 of the case so that the front portion 10 of the case is kept clear for viewing the mobile terminal and its display in embodiments in which the front portion of the case is at least partially transparent. The embodiment shown by the figures is designed for a mobile phone, and therefore the input and output components correspond to some or all of the input and output components of the mobile phone secured therein. The placement, orientation, size, and selection of the components are for illustrative purposes only. The case could be designed and manufactured to contain any number and type of input and output components in any arrangement. For example, other types of input/output components not shown in the figures may include LCDs, touch-screen displays, or devices designed to vibrate the case. Preferably the selection and positioning of input and output components is tailored to the type of mobile terminal to be secured within the case.

The input components of the embodiment shown by FIG. 4 are comprised of a microphone 40, an answer/end key 41, volume keys 42, and a power key 43. The output components are comprised of LED 30, and speaker 31. In this embodiment, the speaker 31 and the microphone 40 allow a conversation to take place. In some embodiments the speaker may be substantially larger than the mobile terminal's speaker to allow the speaker volume to be audible in a noisy environment. If the mobile terminal is capable of receiving voice commands, such as voice dialing, then the microphone 40 can be used for those purposes also. In the shown embodiment, the answer/end key 41 allows the user to answer, hang up, or use voice dialing to place a call. The LEDs 30 provide visual output to the user. For example, the LED may show the state of the connection between the case electronics and the mobile terminal secured therein. An LED may also display an incoming call, missed call, or voicemail message by, for example, blinking brightly.

The input/output components generally extend through and are accessible via corresponding apertures defined by the housing 9, such as the back portion of the housing 11. To protect the mobile terminal from the incursion of water and other contaminants gaskets may also line the apertures defined by the housing so as to form a waterproof seal with the input/output component disposed therein. Additionally or alternatively, the apertures and the input/output components disposed therein may be covered by a thin, typically flexible waterproof material, such as plastic or rubber. Preferably, the speaker is waterproof and the microphone exterior is water-resistant. Additionally, all of the buttons, keys, or keypads on the exterior of the case are typically waterproof or, at least, water-resistant.

The case also carries electronics 50. The electronics contains a signal processor, such as a microprocessor or other computing device for communicating between the mobile terminal and the input/output components carried by the case. The signal processor may be capable of converting signals received by the input components carried by the housing to signals that the mobile terminal is capable of processing. The signal processor would then be capable of transmitting these converted signals from the case to the mobile terminal therein. Additionally or alternatively, the signal processor may be capable of receiving signals from the mobile terminal secured within the housing. The signal processor could then convert these received signals to signals that the output components carried by the housing are capable of processing.

In one embodiment, the signal processor may communicate with the mobile terminal therein using radio frequency signals. In such an embodiment the signal processor would generally include an antenna for transmitting and/or receiving radio frequency signals to and/or from the mobile terminal secured within the housing. The signal processor may use Bluetooth® wireless technology to communicate with the mobile terminal. Bluetooth® is an open radio-frequency standard that enables cable-free voice and data communication between devices through short-range two-way radio (in the radio frequency range of 2.45 gigahertz). Many mobile electronic devices are already Bluetooth® enabled.

In an alternative embodiment the mobile terminal may be hardwired to the case so that the case and the mobile terminal can communicate using electronic signals. The electronic connection between the mobile terminal and the signal processor can comprise an electrical wire, fiber optic cable, a pin, or a direct serial or parallel connection. It should be noted, however, that the present invention is not limited to any specific type of link or frequency for communicating between the signal processor and the mobile terminal secured within the housing. For example, in another embodiment of the present invention, beams of light, such as infrared waves, could also be used to communicate between the mobile terminal and the case components.

The present invention may also contain a power supply, such as a battery 51, carried by the case, for powering the case electronics and input/output components. In particular, the battery could be useful for providing power sufficient to amplify the output signals provided by the output component(s) so that the output signals are more perceptible in noisy, bright, dark, or other harsh environments. Additionally or alternatively, a battery carried by the case could provide power to the mobile terminal secured within the case so as to run the mobile terminal or extend the life of the mobile terminal battery. The case may also contain a power port 52 for connecting a power cable for charging the case's battery 51 or powering the case electronics 50 and input/output components. The power port could be located inside the housing, as shown in FIG. 5, or the power port could be located on the exterior of the case. If located on the exterior of the case, the power port would preferably be waterproof or water-resistant like the other input/output components. For example, a removable rubber plug could be inserted into the port when the port is not in use.

In one advantageous embodiment of the present invention, the input/output components and the signal processor carried by the case are removable from the case while still being capable of communicating with the mobile terminal secured within the case. For example, in one embodiment of the present invention, a protective case designed for a mobile phone has a removable speaker, microphone, and signal processor. The speaker, microphone, and signal processor form a wireless headset that can be used to communicate to the mobile terminal, both while secured within the protective housing and once the headset and the mobile terminal have been removed from the housing. In order to protect the mobile terminal and the headset, such as in instances in which the mobile terminal is to be used near water, the mobile terminal and the headset could be inserted into the protective housing and the protective housing sealed, with the microphone and speaker positioned within respective apertures defined by the case so as to permit two-way communication with the user. Thereafter, the case may be opened and the mobile terminal and the headset removed therefrom to permit use of the mobile terminal and the headset apart form the case in a conventional manner. Such an embodiment would provide for a particularly economical case by allowing the user to use a wireless headset both as a hands-free device and as input/output and electronic components of a protective case.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A case for encapsulating a mobile terminal, comprising:
a housing adapted to define an opened position for receiving a mobile terminal and further adapted to define a closed position for securing the mobile terminal therein, said housing comprised of a waterproof material and being sealed in the closed position so as to protect the mobile terminal from an incursion of water;
at least one of an input component carried by said housing for receiving user input and an output component carried by said housing for receiving user output; and
a signal processor carried by said housing for converting at least one of: (i) user input received by said input component to signals that the mobile terminal is capable of processing prior to provision of the signals to the mobile terminal, and (ii) signals received from the mobile terminal to signals that said output component is capable of processing prior to presentation to said output component for providing a corresponding user output.

2. The case for encapsulating a mobile terminal of claim 1, wherein said signal processor is capable of transmitting radio frequency signals to the mobile terminal and said signal processor is further capable of receiving radio frequency signals from the mobile terminal.

3. The case for encapsulating a mobile terminal of claim 1, further comprising an electrical connection between said signal processor and the mobile terminal, said electrical connection capable of transmitting signals from said signal processor to the mobile terminal and from the mobile terminal to said signal processor.

4. The case for encapsulating a mobile terminal of claim 1, wherein said input component is comprised of at least one of a microphone and a keypad having at least one key.

5. The case for encapsulating a mobile terminal of claim 1, wherein said output component is comprised of at least one of a speaker and a visual display.

6. The case for encapsulating a mobile terminal of claim 1, further comprising a fastener for securing the mobile terminal within the case.

7. The case for encapsulating a mobile terminal of claim 6, wherein said fastener is comprised of at least one strap for at least partially encircling the mobile terminal.

8. The case for encapsulating a mobile terminal of claim 1, wherein said housing is comprised of at least two portions.

9. The case for encapsulating a mobile terminal of claim 8, further comprising a hinge coupling one of said portions to another of said portions.

10. The case for encapsulating a mobile terminal of claim 8, further comprising a latch for securing said portions of said housing in the closed position.

11. The case for encapsulating a mobile terminal of claim 8, wherein said housing further comprises at least one gasket between said portions of said housing to create a hermetic seal.

12. The case for encapsulating a mobile terminal of claim 1, wherein said housing is at least partially comprised of an at least partially transparent material.

13. The case for encapsulating a mobile terminal of claim 1, further comprising a power supply carried by said housing for providing power to said input/output component and signal processor.

14. The case for encapsulating a mobile terminal of claim 1, further comprising a strap attached to the housing to aid in the carrying of the case.

15. The case for encapsulating a mobile terminal of claim 1, wherein said input/output component and said signal processor are removable from said housing while still being capable of communicating with the mobile terminal.

16. The case for encapsulating a mobile terminal of claim 1, wherein the housing is buoyant with the mobile terminal secured therein while in the closed position.

17. A mobile terminal assembly comprising:
a mobile terminal; and
a case in which said mobile terminal is removably disposed; said case comprising:
a housing adapted to define an opened position for receiving a mobile terminal and further adapted to define a closed position for securing the mobile terminal therein, said housing comprised of a waterproof material and being sealed in the closed position so as to protect the mobile terminal from an incursion of water;
at least one of an input component carried by said housing for receiving user input and an output component carried by said housing for providing user output; and
a signal processor carried by said housing in communication with said mobile terminal, said signal processor capable of converting user input to signals that the mobile terminal is capable of processing prior to provision of the signals to the mobile terminal, said signal processor also capable of converting signals received from the mobile terminal to signals capable of providing corresponding user output.

18. The mobile terminal assembly of claim 17, wherein said signal processor is capable of transmitting radio frequency signals to said mobile terminal and said signal processor is further capable of receiving radio frequency signals from said mobile terminal.

19. The mobile terminal assembly of claim 17, further comprising an electrical connection between said signal processor and said mobile terminal, wherein said electrical connection is capable of transmitting electrical signals from said signal processor to said mobile terminal and from said mobile terminal to said signal processor.

20. The mobile terminal assembly of claim 17, further comprising a fastener for securing said mobile terminal within the case.

21. The mobile terminal assembly of claim 17, wherein said housing is comprised of at least two portions.

22. The mobile terminal assembly of claim 21 wherein said housing further comprises at least one gasket between said portions of said housing to create a hermetic seal.

23. The mobile terminal assembly of claim 17, wherein said housing is at least partially comprised of at least partially transparent material.

24. The mobile terminal assembly of claim 17, further comprising a power supply carried by said housing for providing power to said input/output component and signal processor.

25. The mobile terminal assembly of claim 17, wherein said input and output components and said signal processor are removable from said housing while still being capable of communicating with said mobile terminal secured within said housing.

26. The mobile terminal assembly of claim 17, wherein the housing is buoyant with the mobile terminal secured therein while in the closed position.

27. A method for protecting a mobile terminal and an associated headset, the method comprising the steps of:
securing the mobile terminal and the headset with the housing;
receiving user input and providing user output via a microphone and speaker of the headset, respectively, while the headset is secured within the housing;
transmitting signals between the headset and the mobile terminal while the headset and the mobile terminal remain within the housing; and
removing the mobile terminal and the headset from the housing such that the mobile terminal and the headset are capable of subsequently being utilized apart from the housing.

28. The method of claim 27, wherein transmitting signals between the headset and the mobile terminal comprises transmitting radio frequency signals between the headset and the mobile terminal.

29. The method of claim 27, wherein transmitting signals between the headset and the mobile terminal comprises transmitting electrical signals between the headset and the mobile terminal.

30. The method of claim 27, further comprising also receiving user input by a keypad carried by the housing and having at least one key.

31. The method of claim 27, further comprising hermetically sealing the housing with the mobile terminal therein such that the housing is waterproof.
